(19) United States
(12) Patent Application Publication
(10) Pub. No.: US 2022/0247582 A1
(43) Pub. Date: Aug. 4, 2022

(54) DATA MANAGEMENT METHOD, DATA DISTRIBUTION SYSTEM, COMPUTER PROGRAM AND RECORDING MEDIUM

(71) Applicant: NEC Corporation, Minato-ku, Tokyo (JP)

(72) Inventors: Batnyam Enkhtaivan, Tokyo (JP); Sanami Nakagawa, Tokyo (JP); Keisuke Kajigaya, Tokyo (JP); Takao Takenouchi, Tokyo (JP)

(73) Assignee: NEC Corporation, Minato-ku, Tokyo (JP)

(21) Appl. No.: 17/613,625

(22) PCT Filed: May 31, 2019
(86) PCT No.: PCT/JP2019/021689

§ 371 Date: Nov. 23, 2021

(51) Int. Cl. H04L 9/00; H04L 9/32; H04L 9/40

(52) U.S. Cl. CPC H04L 9/50; H04L 63/20; H04L 9/3213

(57) ABSTRACT

A data management method is a data management method in a data distribution system that manages, by using a blockchain, a distribution of data provided by a data provider. The data management method includes: receiving a token that is included in a second transaction and that indicates a result of determination of “permitted”, after a first transaction is registered in the blockchain and after the second transaction is registered in the blockchain, the first transaction indicating a use request for the data by a data user, the second transaction including the token that indicates a result of determination by the data provider with respect to the use request indicated by the first transaction; and providing the data to the data user on condition that the token is received.

### TECHNICAL FIELD

The present invention relates to a data management method, a data distribution system, a computer program and a recording medium, and, in particular, to a data management method, a data distribution system, a computer program and a recording medium that are associated with an information service, such as, for example, a service that provides personal information.

### BACKGROUND ART

As a technique used in this type of system or service, for example, there is a technique related to a blockchain described in Patent Literatures 1 to 4.

### CITATION LIST

### Patent Literature

Patent Literature 1: JP2019-029013A
Patent Literature 2: JP2018-196097A
Patent Literature 3: JP2018-109994A
Patent Literature 4: International Publication No. WO2018/220708A1

### SUMMARY OF INVENTION

### Technical Problem

In the service that provides the personal information, for example, a mediator such as an information bank and a PDS (Personal Data Service/Store) often manages the personal information instead of each individual. By the way, for example, a data provider such as an individual that provides data like the personal information, the mediator, and a data user such as a business operator that uses the data, often have their own interests and expectations that do not match. On the other hand, if the above three parties do not cooperate with each other, the service that provides the data, such as, for example, personal information, may not be established. Therefore, for example, by registering a history of data provision (e.g., information indicating when, to whom, and what kind of data has been provided) in an open-type blockchain (or so-called public chain) as described in the above Patent Literatures, the transparency of the data provision and the prevention of tampering the provision history are often achieved.

However, even if the history of data provision is registered in the blockchain, it is difficult to confirm later whether or not the data provision indicated by the provision history is legitimate.

In view of the above-described problems, it is therefore an example object of the present invention to provide a data management method, a data distribution system, a computer program, and a recording medium that are configured to verify whether or not the data provision is legitimate.

### Solution to Problem

A data management method according to an example aspect of the present invention is a data management method in a data distribution system that manages, by using a blockchain, a distribution of data provided by a data provider, the data management method including: receiving a token that is included in a second transaction and that indicates a result of determination of “permitted”, after a first transaction is registered in the blockchain and after the second transaction is registered in the blockchain, the first transaction indicating a use request for the data by a data user, the second transaction including the token that indicates a result of determination by the data provider with respect to the use request indicated by the first transaction; and providing the data to the data user on condition that the token is received.

A data distribution system according to an example aspect of the present invention is a data distribution system that manages, by using a blockchain, a distribution of data obtained from a data provider, the data distribution system including: a generation apparatus that generates a second transaction after a first transaction is registered in the blockchain, the first transaction indicating a use request for the data by a data user, the second transaction including a token that indicates a result of determination by the data provider with respect to the use request indicated by the first transaction; a reception unit that receives the token that is included in the second transaction and that indicates a result of determination of “permitted”, from the data user, after the second transaction is registered in the blockchain; and a data provision unit that provides the data to the data user on condition that the token is received by the reception unit.

A computer program according to an example aspect of the present invention allows a computer to perform the data management method according to the example aspect described above.

A recording medium according to an example aspect of the present invention is a recording medium on which the computer program according to the example aspect described above is recorded.

### Advantageous Effects of Invention

According to the data management method, the data distribution system, the computer program, and the recording medium in the respective example embodiments described above, it is possible to verify whether or not the data provision is legitimate.

### BRIEF DESCRIPTION OF THE DRAWINGS

FIG. 1 is a diagram illustrating an overview of a data distribution system according to a first example embodiment.

FIG. 2 is a conceptual diagram illustrating a concept of a data distribution log according to the first example embodiment.

FIG. 3 is a block diagram illustrating a hardware configuration of a data management apparatus according to the first example embodiment.

FIG. 4 is a block diagram illustrating a functional block implemented in a CPU of the data management apparatus according to the first example embodiment.

FIG. 5 is a flowchart illustrating an operation when data is registered in the data distribution system according to the first example embodiment.

FIG. 6 is a flowchart illustrating an operation when the data is requested in the data distribution system according to the first example embodiment.

FIG. 7 is a flowchart illustrating an operation when the data is provided in the data distribution system according to the first example embodiment.

FIG. 8 is a diagram illustrating an overview of a data distribution system according to a second example embodiment.

FIG. 9 is a block diagram illustrating a hardware configuration of a policy management apparatus according to the second example embodiment.

FIG. 10 is a flowchart illustrating an operation when a policy is registered in the data distribution system according to the second example embodiment.

FIG. 11 is a flowchart illustrating an operation when data is required in the data distribution system according to the second example embodiment.

FIG. 12 is a diagram illustrating an overview of a data distribution system according to a third example embodiment.

FIG. 13 is a block diagram illustrating a hardware configuration of a priority determination unit according to the third example embodiment.

FIG. 14 is a flowchart illustrating the operation of the priority determination unit according to the third example embodiment.

### DESCRIPTION OF EXAMPLE EMBODIMENTS

A data management method, a computer program, and a recording medium according to example embodiments will be described with reference to the drawings. The following describes the data management method, the computer program, and the recording medium according to the example embodiments, by using a data distribution system that distributes data, such as, for example, personal information.

### First Example Embodiment

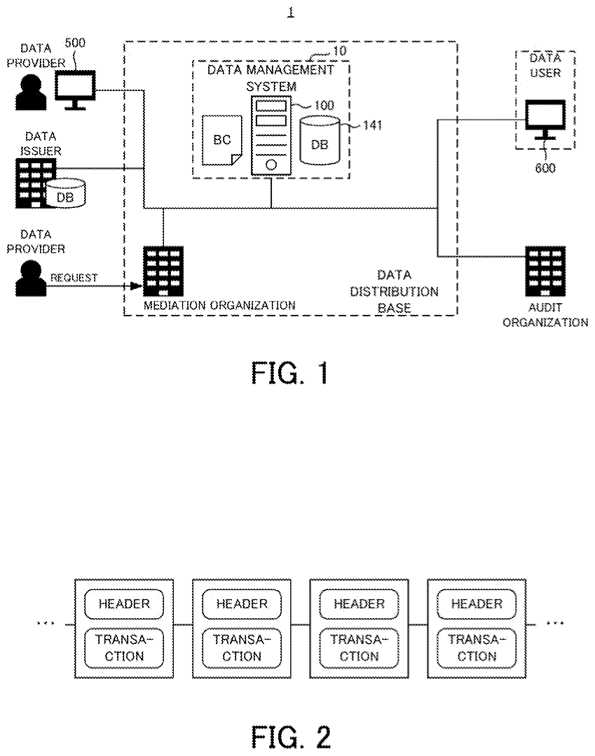

A data distribution system according to a first example embodiment will be described with reference to FIG. 1 to FIG. 7.

(Overview of Data Distribution System)

The overview of a data distribution system 1 according to the first example embodiment will be described with reference to FIG. 1 and FIG. 2. FIG. 1 is a diagram illustrating the overview of the data distribution system according to the first example embodiment. FIG. 2 is a conceptual diagram illustrating a concept of a data distribution log according to the first example embodiment.

In FIG. 1, the data distribution system 1 is provided with a data distribution base including a data management system 10. In the data distribution system 1, the data management system 10 manages data owned by a data provider (e.g., an individual, a business operator that provides data about an individual, etc.), and the data management system 10 provides a data user (typically, an operator) with the data to the extent that is agreed by the data provider. In the first example embodiment, a configuration (or mechanism) that enables secure and safe use of the data owned by the data provider is referred to as the “data distribution base.” The data owned by the data provider is not limited to the personal information, but may be various data, such as, for example, anonymously processed information. In addition, the business operator as data user includes, for example, pharmaceutical companies that use medical information for research purposes, retailers that use purchase information or the like for marketing, and the like.

In the data distribution base, a blockchain is utilized in order to improve the transparency of data distribution. Therefore, a data management apparatus 100 that constitutes the data management system 10, a terminal 500 used by the data provider, and a terminal 600 used by the data user constitute a distributed network such as a Peer-to-Peer (P2P) network. That is, the data management apparatus 100, the terminal 500, and the terminal 600 correspond to nodes of the distributed network.

By the way, an individual as the data provider may be reluctant to accept that a terminal to use becomes the node of the distributed network. Therefore, the first example embodiment includes a mediation organization that provides a field in which the individual as the data provider can utilize the data distribution base without participating in the distributed network. The first example embodiment further includes an audit organization that audits the data distribution via the data distribution base.

In addition, even data about the data provider may be stored by a person who is different from the data provider. An example of the person who is different from the data provider includes, for example, medical institutions that store data on illnesses, health checks, etc., and public safety commissions that store data on driver's licenses, and the like. The person who is different from the data provider is referred to as a “data issuer” in the first example embodiment. Incidentally, the data provider and the data issuer may be the same person (or the same organization). In this case, the data provider is typically a “business operator that provides data on individuals.” Furthermore, a terminal (not illustrated) owned by the data issuer may constitute the node of the distributed network.

Information about the data distribution via the data distribution base is registered in the blockchain. The blockchain is stored in, for example, the data management apparatus 100 that constitutes the distributed network (see a “BC” icon in FIG. 1). In each block of the blockchain, as illustrated in FIG. 2, for example, a header, one or a plurality of transactions and the like are registered.

(Data Management Apparatus)

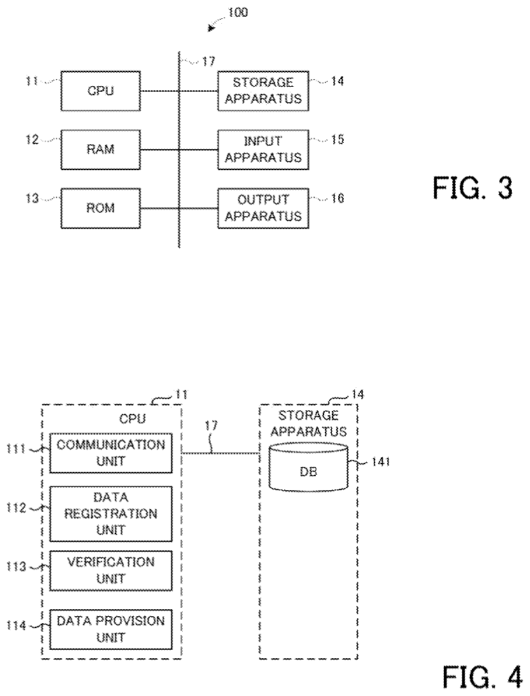

A hardware configuration of the data management apparatus 100 will be described with reference to FIG. 3. FIG. 3 is a block diagram illustrating the hardware configuration of the data management apparatus 100 according to the first example embodiment. When the data management system 10 includes a plurality of data management apparatuses 100, all of the plurality of data management apparatuses 100 may have the hardware configuration illustrated in FIG. 3.

In FIG. 3, the data management apparatus 100 includes a CPU (Central Processing Unit) 11, a RAM (Random Access Memory) 12, a ROM (Read Only Memory) 13, a storage apparatus 14, an input apparatus 15, and an output apparatus 16. The CPU 11, the RAM 12, the ROM 13, the storage apparatus 14, the input apparatus 15, and the output apparatus 16 are interconnected through a data bus 17. The data management apparatus 100 may be constructed as a cloud system. In this case, the input apparatus 15 and the output apparatus 16 may take a configuration corresponding to the cloud system.

The CPU 11 reads a computer program. For example, the CPU 11 may read a computer program stored by at least one of the RAM 12, the ROM 13 and the storage apparatus 14. For example, the CPU 11 may read a computer program stored in a computer-readable recording medium, by using a not-illustrated recording medium reading apparatus. The CPU 11 may obtain (i.e., read) a computer program from a not-illustrated apparatus disposed outside the policy management apparatus 100, through a network interface. The CPU 11 controls the RAM 12, the storage apparatus 14, the input apparatus 15, and the output apparatus 16 by executing the read computer program. Especially in the first example embodiment, when the CPU 11 executes the read computer program, a logical functional block(s) for registering the data from the data provider and for providing the data user with the data is implemented in the CPU 11. In other words, the CPU 11 is configured to function as a controller for realizing the data distribution. A configuration of the functional block implemented in the CPU 11 will be described in detail later with reference to FIG. 4.

The RAM 12 temporarily stores the computer program to be executed by the CPU 11. The RAM 12 temporarily stores the data that is temporarily used by the CPU 11 when the CPU 11 executes the computer program. The RAM 12 may be, for example, a D-RAM (Dynamic RAM).

The ROM 13 stores the computer program to be executed by the CPU 11. The ROM 13 may otherwise store fixed data. The ROM 13 may be, for example, a P-ROM (Programmable ROM).

The storage apparatus 14 stores the data that is stored for a long term by the data management apparatus 100. The storage apparatus 14 may operate as a temporary storage apparatus of the CPU 11. The storage apparatus 14 may include, for example, at least one of a hard disk apparatus, a magneto-optical disk apparatus, an SSD (Solid State Drive), and a disk array apparatus.

The input apparatus 15 is an apparatus that receives an input instruction from a user of the data management apparatus 100. The input apparatus 15 may include, for example, at least one of a keyboard, a mouse, and a touch panel.

The output apparatus 16 is an apparatus that outputs information about the data management apparatus 100, to the outside. For example, the output apparatus 16 may be a display apparatus that is configured to display information about the data management apparatus 100.

Next, the configuration of the functional block implemented in the CPU 11 will be described with reference to FIG. 4. FIG. 4 is a block diagram illustrating the functional block implemented in the CPU 11.

As illustrated in FIG. 4, a communication unit 111, a data registration unit 112, a verification unit 113, and a data provision unit 114 are implemented in the CPU 11 as the logical functional block.

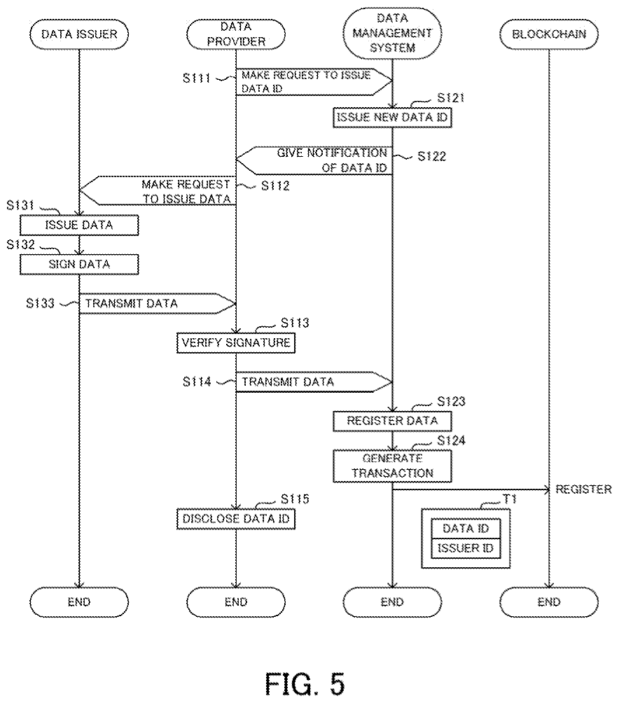

The communication unit 111 and the data registration unit 112 will be described with reference to a flowchart in FIG. 5. FIG. 5 is a flowchart illustrating an operation when the data is registered in the data distribution system 1.

In FIG. 5, when the data provider intends to provide new data, the data provider requests the data management apparatus 100 of the data management system 10 to issue a data ID (i.e., an ID of the new data to be provided) via the terminal 500 or the mediation organization (step S111). The data registration unit 112 of the data management apparatus 100 that has received a data ID issuance request issues a new data ID (step S121). At this time, the data management apparatus 100 performs predetermined authentication processing on the data provider (e.g., ID, password authentication, etc.).

Here, the data ID may include, for example, a specific information about the data management system 10 that issues the data ID and an identification information in the data management system 10. For example, when the specific information about the data management system 10 is “0AB083DE” and the identification information in the data management system 10 is “0000012345”, the data ID to be issued may be “0AB083DE0000012345”. The specific information about the data management system 10 may be information indicating a public key of the data management system 10 in a public key cryptosystem.

The communication unit 111 of the data management apparatus 100 notifies the terminal 500 or the mediation organization of the data ID issued in the step S121 (step S122). As a result, the data provider obtains the data ID issued in the step S121. The data provider then requests the data issuer to issue the new data to be provided (step S112). Incidentally, a data issuance request to the data issuer may be made via the terminal 500 or the mediation organization, or may be made by other means. The data issuance request includes the data ID and information indicating the data to be issued (i.e., the new data to be provided by the data provider).

A data issuing apparatus (not illustrated) owned by the data issuer issues the data in accordance with the data issuance request (step S131). At this time, the data issuing apparatus adds a signature (e.g., digital signature, etc.) of the data issuer to the issued data. Then, the data issuing apparatus transmits the signed data to the terminal 500 or the mediation organization (in other words, the data provider) (step S133).

Here, the data issued by the data issuer includes: the data ID (i.e., the data ID issued in the step S121); explanatory information indicating, for example, the purpose of use of the data, a usage period, a data usage fee or the like; the signature of the data issuer; and the like, in addition to the entity of the data. The signature of the data issuer makes it possible to improve the reliability of the issued data.

The terminal 500 or the mediation organization that has received the data issued by the data issuer automatically verifies the signature of the data issuer (step S113). A result of verification of the signature may be presented to the data provider. Incidentally, since various existing aspects are applicable to the verification of the signature, a detailed description thereof will be omitted. On condition that the signature is confirmed to be authentic, the terminal 500 or the mediation organization transmits the data issued by the data issuer to the data management apparatus 100 (step S114).

The data registration unit 112 of the data management apparatus 100 registers the new data (that is, the data transmitted in the step S114) in a database 141 (see FIG. 4) implemented in the storage apparatus 14, for example (step S123). In parallel with the step S123, the data registration unit 112 generates a transaction T1 including the data ID of the new data and an issuer ID of the issuer that has issued the new data (step S124). In addition to the data ID and the issuer ID, the transaction T1 may include, for example, explanatory information indicating the type of data, the purpose of use, a usage period, a data usage fee, and the like.

The transaction T1 is subsequently registered in the blockchain. The registration of the transaction T1 in the blockchain allows the newly available data to be known to the data user. Furthermore, after the step S114, the terminal 500 or the mediation organization may disclose the data ID of the data transmitted to the data management apparatus 100 (i.e., the new data) (step S115).

When the data provider and the data issuer are the same person (or the same organization), as a result of the step S122, the data provider that has obtained the data ID issues the new data to be provided and transmits it to the data management apparatus 100.

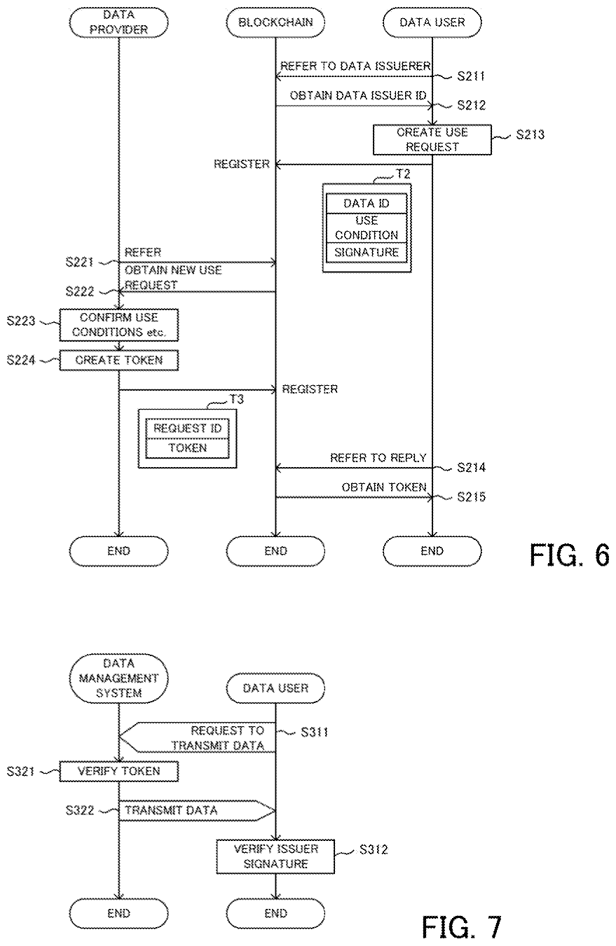

Before describing the verification unit 113 and the data provision unit 114, the exchange between the data user and the data provider that is a premise of the operation of the verification unit 113 and the data provision unit 114 will be described with reference to a flowchart in FIG. 6.

In FIG. 6, the data user who desires to use the data indicated by the transaction T1 registered in the blockchain refers to the issuer ID included in the transaction T1 (that is, the issuer ID of the data issuer that issues the data indicated by the transaction T1) via the terminal 600 (step S211) and obtains the issuer ID from the blockchain (step S212).

For example, when the data user determines that the data issuer related to the issuer ID obtained in the step S212 is reliable, the data user creates a use request for data via the terminal 600 (step S213). The use request includes: the data ID of desired data (here, the data indicated by the transaction T1); conditions of use, such as, for example, the purpose of use, a usage period, a data usage fee, and condition of use of handling charges; the signature of the data user, and the like. The information included in the use request will be hereinafter referred to as a “data use information”, as occasion demands. As a result of the step S213, a transaction T2 indicating the use request is created. The transaction T2 is subsequently registered in the blockchain. The registration of the transaction T2 in the blockchain allows the use request to be known to the data provider.

When the data provider refers to the blockchain via the terminal 500 or the mediation organization, or when the data provider that has received a notification automatically transmitted from the terminal 500 (or a so-called push notification) or a notification from the mediation organization notices the transaction T2 (step S221), the data provider obtains the use request indicated by the transaction T2 from the blockchain via the terminal 500 or the mediation organization (step S222).

The data provider confirms the content of the obtained use request (i.e., the data use information) (step S223) and determines whether data is available or not. Then, the data provider creates a token indicating a result of the determination via the terminal 500 or the mediation organization (step S224). This token corresponds to a reply of the data provider to the use request of the data user. As a result of the step S224, a transaction T3 including the token and a request ID of the use request obtained in the step S222 (e.g., a transaction ID of the transaction T2) is created. The transaction T3 is subsequently registered in the blockchain. The registration of the transaction T3 in the blockchain allows the token corresponding to the reply of the data provider to the use request to be known to the data user.

The token includes, for example, a user ID of the data user, the data ID, a result of determination by the data provider, a creation date, an expiration date, the signature of the data provider, and the like. The user ID may be obtained on the basis of the signature of the data user included in the transaction T2.

After the transaction T3 is registered in the blockchain, the data user refers to the transaction T3 via the terminal 600 (step S214). Then, the data user obtains the token included in the transaction T3 via the terminal 600 (step S215).

Here, when the result of determination by the data provider indicated by the obtained token is positive (e.g., “permitting the use of data”, etc.), it means that the data user has obtained the consent of the data provider. The token indicating the positive result of determination by the data provider will be hereinafter referred to as a “permission token” as occasion demands. On the other hand, when the result of determination by the data provider indicated by the obtained token is negative (e.g., “not permitting the use of data”, etc.), it means that the data user is not able to obtain the consent of the data provider. When the token indicating the negative result of determination by the data provider is included in the transaction T3, the data user does not need to obtain the token (that is, the step S215 described above may not be performed).

Next, the verification unit 113 and the data provision unit 114 will be described with reference to a flowchart in FIG. 7. FIG. 7 is a flowchart illustrating an operation when the data is provided in the data distribution system 1.

In FIG. 7, the data user who has obtained the consent of the data provider requests the data management apparatus 100 of the data management system 10 to transmit the data via the terminal 600 (step S311). The permission token obtained in the step S215 described above is added to the data transmission request. The data transmission request is received by the communication unit 111 of the data management apparatus 100.

The verification unit 113 of the data management apparatus 100 that has received the data transmission request verifies the signature of the data provider included in the permission token (step S321). On condition that the signature is confirmed to be authentic, the data provision unit 114 transmits the requested data together with the signature of the data issuer to the terminal 600 (in other words, the data user) (step S322). At this time, a history of data transmission to the terminal 600 (i.e., the data user) may be recorded in the data management apparatus 100 or may be registered in the blockchain.

The terminal 600 that has received the data transmitted in the step S322 automatically verifies the signature of the data issuer (step S312). A result of verification of the signature may be presented to the data user.

The “transaction T2”, the “transaction T3”, and the “transaction T1” respectively correspond to examples of the “first transaction”, the “second transaction”, and the “third transaction” in the Supplementary Note described later. The “communication unit 111” and the “data provision unit 114” respectively correspond to examples of “reception unit” and “provision unit” in the Supplementary Note described later.

### Technical Effects

In the data distribution system 1, the transaction T2 indicating the use request of the data user and the transaction T3 including the token corresponding to the reply of the data provider to the user request are registered in the blockchain. Therefore, by referring to the blockchain, it is possible to know whether or not an agreement is formed between the data user and the data provider. That is, according to the data distribution system 1, it is possible to verify whether or not the data provision is legitimate.

In addition, the data management system 10 (or the data management apparatus 100) of the data distribution system 1 provides the data to the data user only when the permission token (i.e., the token indicating the positive result of determination by the data provider), which is a proof of formation of the agreement between the data user and the data provider) is presented by the data user. In other words, the data management system 10 (or the data management apparatus 100) does not provide the data to the data user unless the permission token is presented. Therefore, according to the data distribution system 1, it is possible to ensure that the data is provided in accordance with the agreement between the data user and the data provider.

Furthermore, when the audit organization conducts an audit, the process of formation of the agreement between the data user and the data provider can be confirmed by referring to the blockchain, which is very advantageous in practical use.

### Modified Example

The data issuer may create a transaction T4 including the data ID of data to be revoked, a state information indicating revocation of the data corresponding to the data ID, and the issuer ID of the data issuer, in order to revoke the data that is made available by registering the transaction T1 in the blockchain. In this case, the terminal owned by the data issuer constitutes the node of the distributed network.

In this modified example, when creating the use request, the data user firstly refers to the blockchain and confirms whether or not the transaction T4 related to the desired data is registered (i.e., whether or not the desired data is revoked). The data user creates the use request after confirming that the desired data is not revoked.

For example, data about a driver's license may be revoked before the expiration date thereof due to return or cancellation caused by a violation. In such a case, when the data issuer can revoke the data that is already available in the data distribution system 1 by generating the transaction T4, it is possible to avoid a situation in which the already revoked data continues to be used in the data distribution system 1.

### Second Example Embodiment

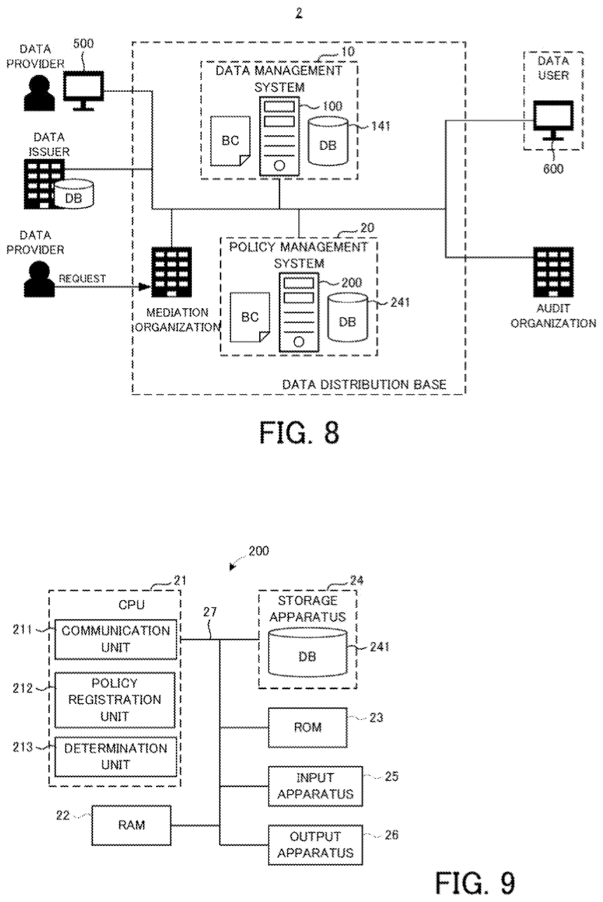

A data distribution system according to a second example embodiment will be described with reference to FIG. 8 to FIG. 11. The second example embodiment is the same as the first example embodiment described above, except that the configuration of the data distribution system is partially different. Therefore, in the second example embodiment, the description that overlaps with that of the first example embodiment will be omitted, and the same parts on the drawings will be denoted by the same reference numerals. Basically, different points will be described with reference to FIG. 8 to FIG. 11.

(Overview of Data Distribution System)

The overview of a data distribution system 2 according to the second example embodiment will be described with reference to FIG. 8. FIG. 8 is a diagram illustrating the overview of the data distribution system according to the second example embodiment.

In FIG. 8, the data distribution system 2 includes a data distribution base including a policy management system 20 in addition to the data management system 10. In the first example embodiment described above, the data provider determines the availability of the use request of the data user. In the second example embodiment, the policy management system 20 determines the availability of the use request of the data user on behalf of the data provider.

(Policy Management Apparatus)

A hardware configuration of a policy management apparatus 200 that constitutes the policy management system 20 will be described with reference to FIG. 9. FIG. 9 is a block diagram illustrating the hardware configuration of the policy management apparatus 200 according to the second example embodiment. When the policy management system 20 includes a plurality of policy management apparatuses 200, all of the plurality of policy management apparatuses 200 may have the hardware configuration illustrated in FIG. 9.

In FIG. 9, the policy management apparatus 200 includes a CPU 21, a RAM 22, a ROM 23, a storage apparatus 24, an input apparatus 25, and an output apparatus 26. The CPU 21, the RAM 22, the ROM 23, the storage apparatus 24, the input apparatus 25, and the output apparatus 26 are interconnected through a data bus 27. In the CPU 21, a communication unit 211, a policy registration unit 212, and a determination unit 213 are implemented as the logical functional block.

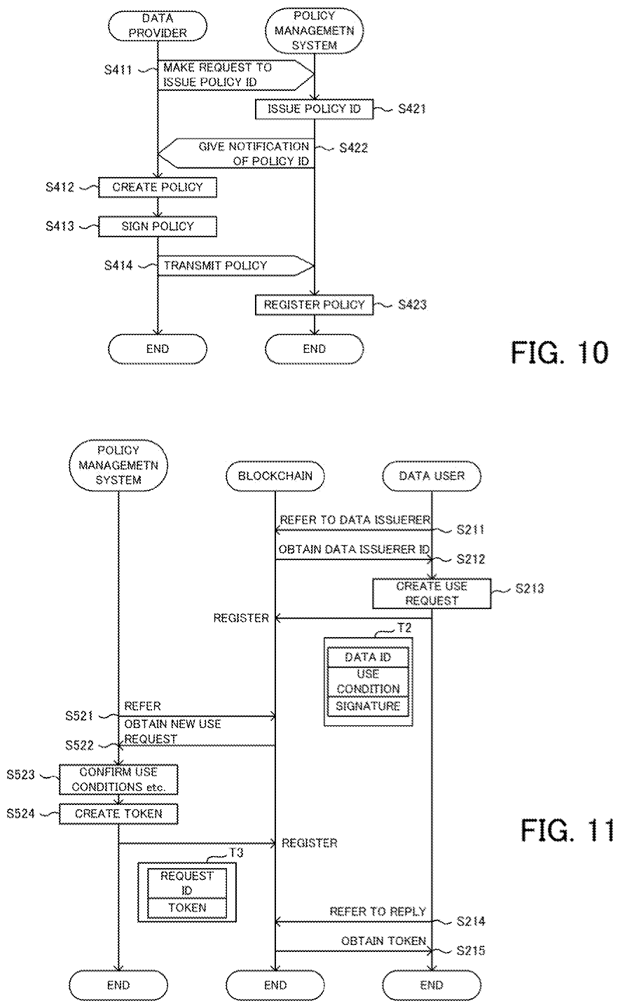

The communication unit 211 and the policy registration unit 212 will be described with reference to a flowchart in FIG. 10. FIG. 10 is a flowchart illustrating an operation when a policy is registered in the data distribution system 2.

In FIG. 10, when the data provider is about to register a policy (i.e., a data protection policy) on the data to be provided, the data provider requests the policy management apparatus 200 of the policy management system 20 to issue a policy ID via the terminal 500 or the mediation organization (step S411). The policy registration unit 212 of the policy management apparatus 200 that has received the request for issuance of the policy ID issues the policy ID (step S421).

Here, a policy information is, for example, the information that defines a policy on whether or not to permit data provision, and is mainly determined by the data provider itself. Specific examples of the policy include the purpose, period, and destination of use of data to be permitted. In addition, there may be a policy that indicates the rejection of the data provision to a specific company (e.g., a company that has caused information leakage self, etc.). The policy ID may include, for example, a specific information about the policy management system 20 that issues the policy ID and an identification information in the policy management system 20, as in the data ID described above.

The communication unit 211 of the policy management apparatus 200 notifies the terminal 500 or the mediation organization of the policy ID issued in the step S421 (step S422). As a result, the data provider obtains the policy ID issued in the step S421.

The data provider creates the policy information indicating the policy (step S412) and adds the signature of the data provider to the created policy information (step S413). Here, the policy information includes: the policy ID (that is, the policy ID issued in the step S421); explanatory information indicating, for example, the purpose of use, a usage period, a data usage fee or the like permitted by the data provider; the signature of the data provider; and the like, in addition to information indicating the content of the policy.

Then, the data provider transmits the signed policy information to the policy administration apparatus 200 via the terminal 500 or the mediation organization (step S414). The policy registration unit 212 of the policy management apparatus 200 stores the policy information (that is, the policy information transmitted in the step S414), for example, in a database 241 implemented in the storage apparatus 24 (see FIG. 9) (step S423).

After the step S423, every time the data provider registers the data in the data management system 10 (or the data management apparatus 100), the policy registration unit 212 adds the data ID of the registered data to the policy information stored in the database 241.

Next, a description will be given to the determination unit 213 with reference to a flowchart in FIG. 11. FIG. 11 is a flowchart illustrating an operation when the data is requested in the data distribution system 2.

In FIG. 11, the determination unit 213 of the policy management apparatus 200 sequentially refers to (or monitors) the blockchain (step S521). When detecting the transaction T2 indicating a new use request of the data user, the determination unit 213 obtains the use request indicated by the detected transaction T2 from the blockchain (step S522).

The determination unit 213 confirms the content of the obtained use request (i.e., the data use information) (step S523) and specifies the policy information including the data ID of the desired data included in the use request. Then, the determination unit 213 determines whether or not the data is available on the basis of the information indicating the content of the policy included in the specified policy information and the obtained use request (specifically, for example, the determination unit 213 determines whether or not the use request matches the content of the policy). After that, the determination unit 213 creates the token indicating a result of the determination (step S524).

### Technical Effects

Especially in the data distribution system 2, the policy management system 20 (or the policy management apparatus 200) automatically determines the availability of the data on behalf of the data provider. Therefore, according to the data distribution system 2, it is possible to significantly reduce a burden on the data provider.

### Modified Example

The determination unit 213 of the policy management apparatus 200 may be configured to request the determination of the data provider for at least a part of the use request. Such a configuration may be realized, for example, by creating a policy indicating that an inquiry is sent to the data provider when there is a use request for data corresponding to a predetermined data ID.

### Third Example Embodiment

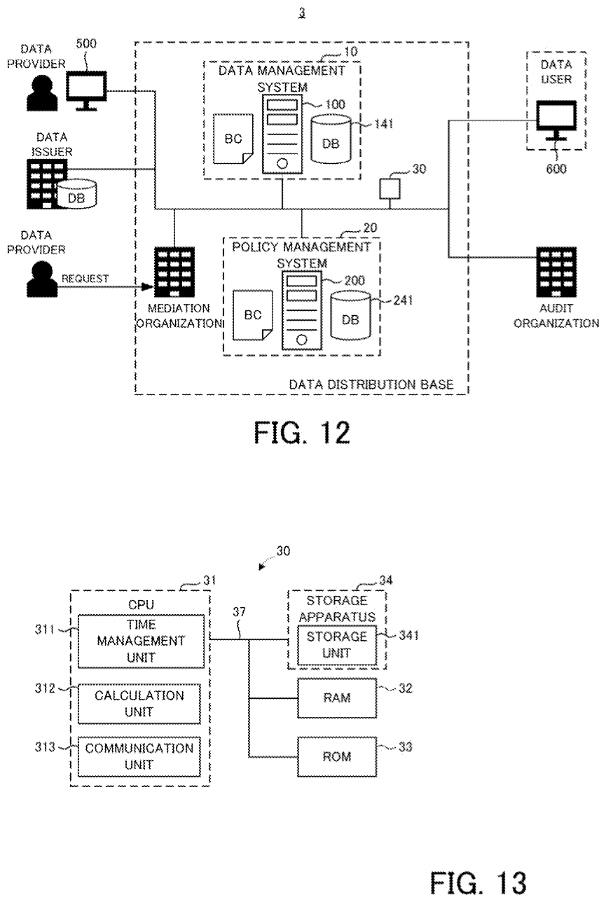

A data distribution system according to a third example embodiment will be described with reference to FIG. 12 to FIG. 14. The third example embodiment is the same as the second example embodiment described above, except that the configuration of the data distribution system is partially different. Therefore, in the third example embodiment, the description that overlaps with that of the second example embodiment will be omitted, and the same parts on the drawings will be denoted by the same reference numerals. Basically, different points will be described with reference to FIG. 12 to FIG. 14.

(Overview of Data Distribution System)

The overview of a data distribution system 3 according to the third example embodiment will be described with reference to FIG. 12. FIG. 12 is a diagram illustrating the overview of the data distribution system according to the third example embodiment.

In FIG. 12, the data distribution system 3 includes a data distribution base including a priority determination unit 30 in addition to the data management system 10 and the policy management system 20. The priority determination unit 30 may be configured as an independent apparatus, or may be configured as a part of another apparatus. The priority determination unit 30 determines a registration priority in the blockchain, for the transaction T2 before it is registered in the blockchain. Note that the data distribution system 3 may not include the policy management system 20.

(Priority Determination Unit)

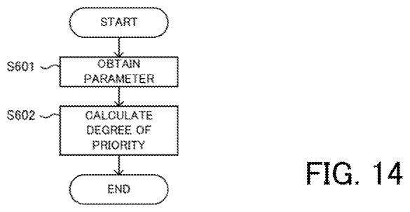

A hardware configuration of the priority determination unit 30 will be described with reference to FIG. 13. FIG. 13 is a block diagram illustrating the hardware configuration of the priority determination unit 30 according to the third example embodiment.

In FIG. 13, the priority determination unit 30 includes a CPU 31, a RAM 32, a ROM 33 and a storage apparatus 34. The CPU 31, the RAM 32, the ROM 33 and the storage apparatus 34 are interconnected through a data bus 37. In the CPU 31, a time management unit 311, an calculation unit 312 and a communication unit 313 are implemented as the logical function block. In the storage apparatus 34, a storage unit 341 (corresponding to a so-called transaction pool) that temporarily stores the transaction T2 before being registered in the blockchain is implemented.

Here, the size of each block that constitutes the blockchain is predetermined. For this reason, the number of transactions that can be registered in each block is limited. On the other hand, if the transaction T2 is not registered in the blockchain, the token indicating the result of the decision by the data provider or the result of the determination by the policy management system on behalf of the data provider with respect to the use request indicated by transaction T2 is not created. That is, in principle, the data distribution system 3 processes the use request from the one indicated by the transaction T2 that is previously registered in the blockchain.

If no measures are taken, there is a technical problem that it is hard to respond to urgent matters, such as, for example, a request for data on a patient transported to an emergency outpatient unit. Therefore, in the third example embodiment, the priority determination unit 30 determines a degree of priority for each transaction T2, so that the transaction T2 to be preferentially registered in the blockchain is determined.

Hereinafter, the operation of the priority determination unit 30 will be specifically described. The time management unit 311 obtains a standby time of each transaction T2 temporarily stored in the storage unit 341. Here, the standby time may be a time from when the transaction T2 is stored in the storage unit 341 to the present. Alternatively, if a creation time of the transaction T2 is known, the standby time may be a time from the creation time to the present.

The calculation unit 312 determines the degree of priority of each transaction T2 on the basis of the data size of each transaction T2 temporarily stored in the storage unit 341, the standby time obtained by the time management unit 311, the content of the use request indicated by the transaction T2 (that is, the data use information), the size of each block that constitutes the blockchain, and the like.

Specifically, the calculation unit 312 increases the degree of priority as at least one of emergency and public benefit that are estimated from the purpose of use (e.g., emergency treatment, etc.), which is the data use information, and from the characteristics of the data user (e.g., emergency life-saving, medical institutions, etc.) specified on the basis of the signature of the data user, which are the data use information, is higher. At this time, the calculation unit 312 may further estimate at least one of the emergency and the public benefit in consideration of the type of data (e.g., medical history, treatment history, etc.) specified on the basis of the data ID of the desired data, which is the data use information.

The characteristics of the data user may be included in the transaction T2. Alternatively, the transaction T2 may include the user ID of the data user in addition to the signature of the data user. When the characteristics of the data user are specified on the basis of the signature of the data user or on the basis of the user ID, the characteristics may be specified from the history of the data user already registered in the blockchain, or may be specified on the basis of a database that indicates a relationship between the data user and the characteristics and that is built in advance.

The calculation unit 312 may also increase the degree of priority as the handling charges (i.e., a fee for the use of the data distribution base), which are the data use information, is higher. The calculation unit 312 may further increase the degree of priority as the standby time is longer.

The communication unit 311 transmits the transaction T2 whose degree of priority is determined among the transactions T2 stored in the storage unit 341 to the distributed network, together with information indicating the degree of priority determined by the calculation unit 312. Alternatively, the communication unit 311 adds the information indicating the degree of priority determined by the calculation unit 312 (e.g., a flag, etc.) to the transaction T2 whose degree of priority is determined among the transactions T2 stored in the storage unit 341, and transmits the transaction T2 whose degree of priority is determined to the distributed network.

When the priority determination unit 30 has the right to create a block and to connect the created block to the blockchain, i.e., when the priority determination unit 30 is a miner, the priority determination unit 30 may register the transaction T2 in the block in accordance with the degree of priority determined by the calculation unit 312.

The operation of the priority determination unit 30 configured as described above will be described with reference to a flowchart in FIG. 14.

In FIG. 14, the calculation unit 312 of the priority determination unit 30 obtains a parameter, such as, for example, the data size, the standby time, and the use request, for each transaction T2 temporarily stored in the storage unit 341 (step S601). Then, the calculation unit 312 calculates (determines) the degree of priority of each transaction T2 on the basis of the obtained parameter (step S602).

### Technical Effects

According to the data distribution system 3, especially, the degree of priority of each transaction T2 is determined by the priority determination unit 30. It is thus possible to appropriately respond to the urgent matters, such as, for example, a request for data on a patient transported to an emergency outpatient unit.

### Fourth Example Embodiment

A data distribution system according to a fourth example embodiment will be described. The fourth example embodiment is the same as the first example embodiment described above, except that the content of the use request related to the transaction T2 is partially different. Therefore, in the fourth example embodiment, the description that overlaps with that of the first example embodiment will be omitted, and the same parts on the drawings will be denoted by the same reference numerals. Basically, different points will be described.

The use request indicated by the transaction T2 includes, as the data use information: the data ID of the desired data; conditions of use, such as, for example, the purpose of use, a usage period, a data usage fee, and handling charges; the signature of the data user, and the like. Here, since the specific content of the conditions of use can be freely described by the data user, the data size of the transaction T2 may be relatively large depending on the specific content of the conditions of use. Also, by its nature, the blockchain has a larger data size as the operation period of the data distribution system 1 is longer.

Therefore, in the fourth example embodiment, the conditions of use are permitted to include a pointer information that refers to information included in another transaction T2 that is already registered in the blockchain (e.g., the transaction ID of this another transaction T2). If the conditions of use includes the pointer information, the conditions of use of this another transaction T2 are referred to as the conditions of use.

In addition to the pointer information, the conditions of use are permitted to include a difference information that indicates a difference from the specific content of the conditions of use of this another transaction T2.

### Technical Effects

According to the fourth example embodiment, especially, it is possible to reduce the data size of the transaction T2. It is thus possible to prevent an increase in the data size of the blockchain.

<Supplementary Note>

With respect to the example embodiments described above, the following Supplementary Notes will be further disclosed.

(Supplementary Note 1)

A data management method described in Supplementary Note 1 is a data management method in a data distribution system that manages, by using a blockchain, a distribution of data provided by a data provider, the data management method including: receiving a token that is included in a second transaction and that indicates a result of determination of “permitted”, after a first transaction is registered in the blockchain and after the second transaction is registered in the blockchain, the first transaction indicating a use request for the data by a data user, the second transaction including the token that indicates a result of determination by the data provider with respect to the use request indicated by the first transaction; and providing the data to the data user on condition that the token is received.

(Supplementary Note 2)

A data management method according to Supplementary Note 2 is the data management method described in Supplementary Note 1, referring to a policy information that indicates a protection policy for the data by the data provider and generating the second transaction including the token, after the first transaction is registered in the blockchain.

(Supplementary Note 3)

A data management method according to Supplementary Note 3 is the data management method described in Supplementary Note 1 or 2, wherein the first transaction includes a data use information about a use of the data, and the data management method determines a degree of priority of registration of the first transaction into the blockchain on the basis of at least one of the data use information and a time at which the first transaction is generated.

(Supplementary Note 4)

A data management method described in Supplementary Note 4 is the data management method described in at least one of Supplementary Notes 1 to 3, wherein one transaction as the first transaction includes, as the use request, information about another transaction that is already registered in the blockchain as the first transaction and that is different from the one transaction.

(Supplementary Note 5)

A data management method according to Supplementary Note 5 is the data management method described in Supplementary Note 4, wherein the information about the another transaction includes a pointer information that refers to information included in the another transaction, and the one transaction does not include the information included in the another transaction when including the pointer information.

(Supplementary Note 6)

A data management method described in Supplementary Note 6 is the data management method described in at least one of Supplementary Notes 1 to 5, generating a third transaction indicating an identification information about the data, after the data is obtained from the data provider.

(Supplementary Note 7)

A data distribution system according to Supplementary Note 7 is a data distribution system that manages, by using a blockchain, a distribution of data obtained from a data provider, the data distribution system including: a generation apparatus that generates a second transaction after a first transaction is registered in the blockchain, the first transaction indicating a use request for the data by a data user, the second transaction including a token that indicates a result of determination by the data provider with respect to the use request indicated by the first transaction; a reception unit that receives the token that is included in the second transaction and that indicates a result of determination of “permitted”, from the data user, after the second transaction is registered in the blockchain; and a data provision unit that provides the data to the data user on condition that the token is received by the reception unit.

(Supplementary Note 8)

A data distribution system according to Supplementary Note 8 is the data distribution system described in Supplementary Note 7, wherein the generation apparatus includes at least one of a terminal apparatus used by the data provider and a policy management apparatus that manages a policy information that indicates a protection policy for the data by the data provider.

(Supplementary Note 9)

A computer program described in Supplementary Note 9 is a computer program that allows a computer to execute the management method described in Supplementary Note 1.

(Supplementary Note 10)

A recording medium described in Supplementary Note 10 is a recording medium on which the computer program described in Supplementary Note 9 is recorded.

The present invention is not limited to the above-described examples and is allowed to be changed, if desired, without departing from the essence or spirit of the invention which can be read from the claims and the entire specification. A data management method, a data distribution system, a computer program and a recording medium, which involve such changes, are also intended to be within the technical scope of the present invention.

### DESCRIPTION OF REFERENCE CODES

1, 2, 3 . . . Data distribution system, 10 . . . Data management system, 11, 21, 31 . . . CPU, 12, 22, 32 . . . RAM, 13, 23, 33 . . . ROM, 14, 24, 34 . . . Storage apparatus, 15, 25 . . . Input apparatus, 16, 26 . . . Output apparatus, 20 . . . Policy management system, 30 . . . Priority determination unit, 100 . . . Data management apparatus, 111, 211, 313 . . . Communication unit, 112 . . . Data registration unit, 113 . . . Verification unit, 114 . . . Data provision unit, 212 . . . Policy registration unit, 213 . . . Determination unit, 311 . . . Time management calculating unit 312 . . . Calculation unit, 141, 241 . . . Database, 200 . . . Policy management unit, 341 . . . Storage unit

What is claimed is:

1. A data management method in a data distribution system that manages, by using a blockchain, a distribution of data provided by a data provider,
the data management method comprising:
receiving a token that is included in a second transaction and that indicates a result of determination of “permitted”, after a first transaction is registered in the blockchain and after the second transaction is registered in the blockchain, the first transaction indicating a use request for the data by a data user, the second transaction including the token that indicates a result of determination by the data provider with respect to the use request indicated by the first transaction; and
providing the data to the data user on condition that the token is received.

2. The data management method according to claim 1 referring to a policy information that indicates a protection policy for the data by the data provider and generating the second transaction including the token, after the first transaction is registered in the blockchain.

3. The data management method according to claim 1, wherein
the first transaction includes a data use information about a use of the data,
the data management method determines a degree of priority of registration of the first transaction into the blockchain on the basis of at least one of the data use information and a time at which the first transaction is generated.

4. The data management method according to claim 1, wherein one transaction as the first transaction includes, as the use request, information about another transaction that is already registered in the blockchain as the first transaction and that is different from the one transaction.

5. The data management method according to claim 4, wherein
the information about the another transaction includes a pointer information that refers to information included in the another transaction, and
the one transaction does not include the information included in the another transaction when including the pointer information.

6. A data distribution system that manages, by using a blockchain, a distribution of data obtained from a data provider,
the data distribution system comprising:
a generation apparatus that generates a second transaction after a first transaction is registered in the blockchain, the first transaction indicating a use request for the data by a data user, the second transaction including a token that indicates a result of determination by the data provider with respect to the use request indicated by the first transaction;
a reception unit that receives the token that is included in the second transaction and that indicates a result of determination of “permitted”, from the data user, after the second transaction is registered in the blockchain; and
a data provision unit that provides the data to the data user on condition that the token is received by the reception unit.

7. The data distribution system according to claim 6, wherein the generation apparatus includes at least one of a terminal apparatus used by the data provider and a policy management apparatus that manages a policy information that indicates a protection policy for the data by the data provider.

8. (canceled)

9. A non-transitory recording medium on which a computer program recorded,
a computer program that allows a computer to execute the data management method,
the data management method is a method in a data distribution system that manages, by using a blockchain, a distribution of data provided by a data provider,
the data management method comprising:
receiving a token that is included in a second transaction and that indicates a result of determination of “permitted”, after a first transaction is registered in the blockchain and after the second transaction is registered in the blockchain, the first transaction indicating a use request for the data by a data user, the second transaction including the token that indicates a result of determination by the data provider with respect to the use request indicated by the first transaction; and
providing the data to the data user on condition that the token is received.
